(19) United States
(12) Patent Application Publication
(10) Pub. No.: US 2012/0090205 A1
(43) Pub. Date: Apr. 19, 2012

(54) THREE-DIMENSIONAL GREETING CARD AND PROTECTIVE CASE THEREFOR

(76) Inventors: Nobuaki Uno, Tokyo (JP); Susumu Hashimoto, Tokyo (JP); Kenji Nishioka, Tokyo (JP); Toshiki Akiyama, Tokyo (JP)

(21) Appl. No.: 13/262,852

(22) PCT Filed: Nov. 24, 2009
(86) PCT No.: PCT/JP2009/006296

§ 371 Date: Dec. 14, 2011

(30) Foreign Application Priority Data
Jul. 21, 2009 (JP) 2009-169782

(51) Int. Cl. G09F 1/00; B65D 65/02

(52) U.S. Cl. 40/124.01; 150/154

(57) ABSTRACT

Provided is a greeting card which provides a three-dimensional effect and enables the change of the layout of a picture. Also provided is a protective case for a greeting card which enables the greeting card to be viewed in a standing state. Specifically, provided is a three-dimensional greeting card including a picture part formed in at least part of a greeting card body, the picture part being configured by sticking an appropriate number of constituent picture pieces on top of one another. Also specifically, provided is a protective case for a greeting card, including a transparent plastic case body including upper and lower openings, the protective case further including: a protruding piece for forming a foot part, the protruding piece being formed at the lower opening so as to be outwardly bendable; and a protruding piece for forming a greeting card receiving part, the protruding piece being formed at the lower opening so as to be inwardly bendable.

### FIELD OF THE INVENTION

The present invention relates to a three-dimensional greeting card and a protective case therefor.

### BACKGROUND OF THE INVENTION

A greeting card is widely utilized for: celebration of a birthday and entrance into a school; invitation to social gathering and a welcome/farewell party; announcement of opening of a shop and a change of address; and the like.

Then, the conventional greeting card generally includes a picture part and a message space part. The picture part simply has a mere two-dimensional picture (see, for example, Patent Document 1), thus resulting in a problem that a three-dimensional effect cannot be obtained. Moreover, the picture is printed, and hence is completely impossible for a person who receives the greeting card to change the layout of the picture.

In addition, the conventional greeting card is a card made of thin paper, and hence it is necessary in actuality to utilize a picture stand and the like in order to store or view the card.

### PRIOR ART DOCUMENT

### Patent Document

[Patent Document 1] JP-A-07-52585

### SUMMARY OF THE INVENTION

The present invention has been made in view of the conventional problem and actuality as described above, and therefore has an object to provide a greeting card which provides a three-dimensional effect and enables the change of the layout of a picture.

Also, the present invention has an object to provide a protective case for a greeting card which is suitably used for transporting or storing the greeting card, and more particularly, a protective case which enables the greeting card to be viewed in a standing state without using a picture stand.

In order to achieve the above-mentioned objects, the present invention provides a three-dimensional greeting card including a picture part formed in at least part of a greeting card body, the picture part being configured by sticking an appropriate number of constituent picture pieces on top of one another.

In addition, in order to achieve the above-mentioned objects, the present invention provides the three-dimensional greeting card, in which the constituent picture pieces are stuck on top of one another so as to be detachably attached by a sheet fastener.

In addition, in order to achieve the above-mentioned objects, the present invention provides a protective case for a greeting card, including a transparent plastic case body including upper and lower openings, the protective case further including: a protruding piece for forming a foot part, the protruding piece being formed at the lower opening so as to be outwardly bendable; and a protruding piece for forming a greeting card receiving part, the protruding piece being formed at the lower opening so as to be inwardly bendable.

In addition, in order to achieve the above-mentioned objects, the present invention provides the protective case for a greeting card, further including a protruding piece for forming a greeting card engaging part, the protruding piece being formed at the upper opening of the transparent plastic case body so as to be inwardly bendable.

In addition, in order to achieve the above-mentioned objects, the present invention provides a three-dimensional greeting card including the greeting card housed in the protective case.

With the three-dimensional greeting card according to the present invention, a viewer can view the picture part with a three-dimensional effect being provided. In particular, if an embodiment in which the constituent picture piece is detachably attached by the sheet fastener is adopted, a person who receives the greeting card can freely change the layout of the picture part.

In addition, with the protective case according to the present invention, the three-dimensional greeting card having a thickness can be housed to be safely transported or stored. Further, the greeting card can be displayed in a standing state, and thus can be viewed without particularly using a picture stand and the like.

### BRIEF DESCRIPTION OF DRAWINGS

FIG. 1 is an explanatory plan view schematically illustrating a three-dimensional greeting card according to the present invention.

FIG. 2 is an explanatory cross-sectional view schematically illustrating the three-dimensional greeting card according to the present invention.

FIG. 3 is an explanatory cross-sectional view schematically illustrating a constituent picture piece and a spacer.

FIG. 4 is an explanatory front view schematically illustrating a protective case according to the present invention.

FIG. 5 is an explanatory rear view schematically illustrating the protective case according to the present invention.

FIG. 6 is an explanatory perspective view schematically illustrating a state where the greeting card is housed to be stood in the protective case according to the present invention.

FIG. 7 is an explanatory cross-sectional view schematically illustrating the state where the greeting card is housed to be stood in the protective case according to the present invention.

### DESCRIPTION OF THE INVENTION

Hereinafter, an embodiment of the present invention is described with reference to the drawings.

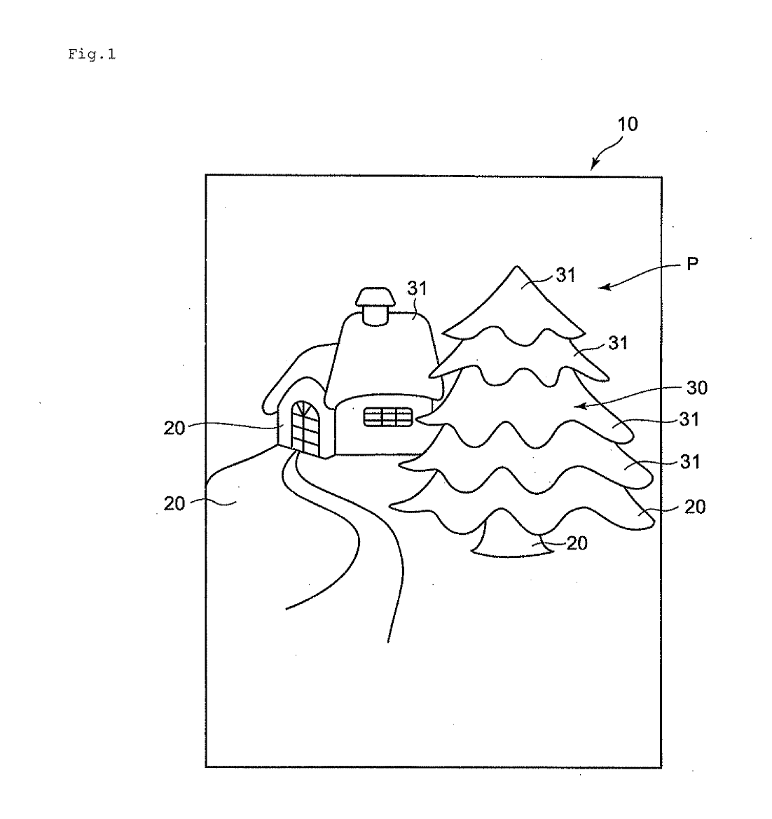

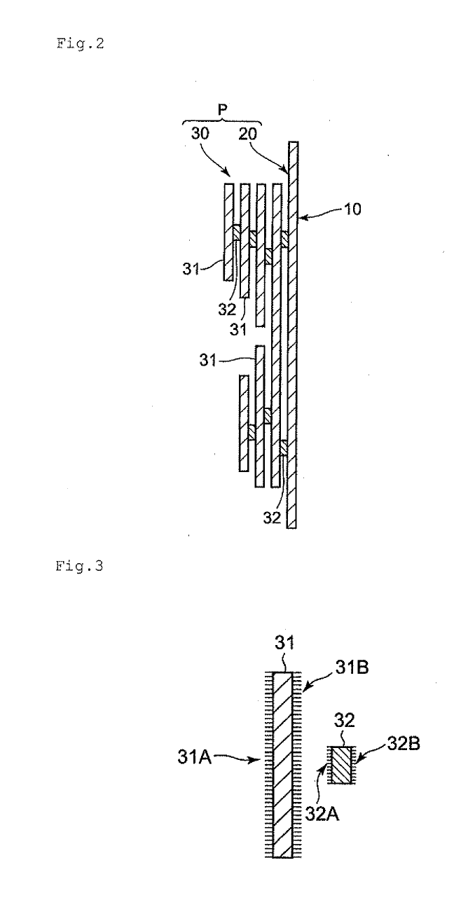

FIG. 1 is an explanatory plan view schematically illustrating a three-dimensional greeting card according to the present invention, and FIG. 2 is an explanatory cross-sectional view schematically illustrating the same. FIG. 3 is an explanatory cross-sectional view schematically illustrating a constituent picture piece and a spacer.

In FIG. 1 to FIG. 3, 10 denotes a greeting card body. A picture part P is formed on a front surface of the greeting card body 10, and a message space (not illustrated) is formed on a rear surface thereof.

The picture part P includes a two-dimensional picture part 20 and a three-dimensional picture part 30. The two-dimensional picture part 20 is displayed by printing and the like on the surface of the greeting card body 10. In addition, the three-dimensional picture part 30 is configured by sticking, for each part, an appropriate number of constituent picture pieces 31 on top of one another, the constituent picture pieces 31 being formed for each part corresponding to each part of the two-dimensional picture part 20. Note that, the specific size and shape of the constituent picture piece 31 is determined as appropriate in accordance with a picture design and the like.

When the constituent picture pieces 31 are stuck on top of one another, it is more desirable to interpose a spacer 32 therebetween as appropriate. This is because even a small number of constituent picture pieces stuck on top of one another can provide a three-dimensional effect.

In addition, as illustrated in FIG. 3, it is more desirable that sheet fastener parts 31A, 31B and 32A, 32B be respectively formed on front and rear surfaces of the constituent picture piece 31 and the spacer 32, whereby the constituent picture piece 31 and the spacer 32 are detachably attached to each other. With this configuration, the layout of the picture part P can be changed.

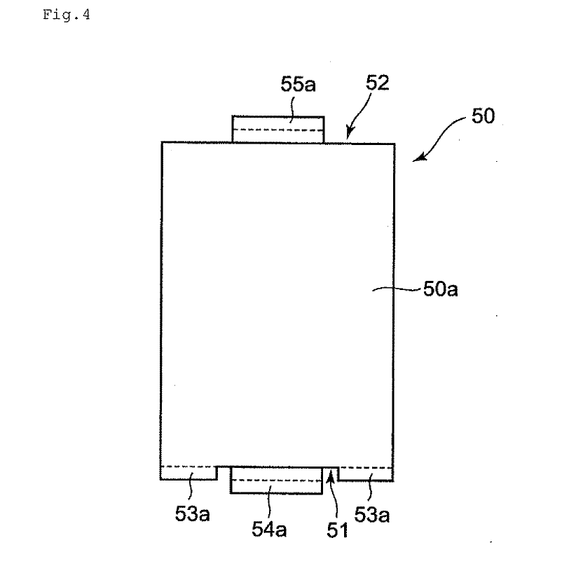

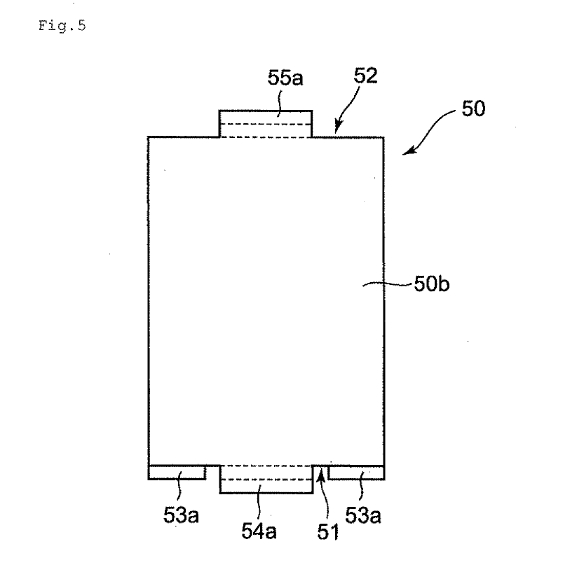

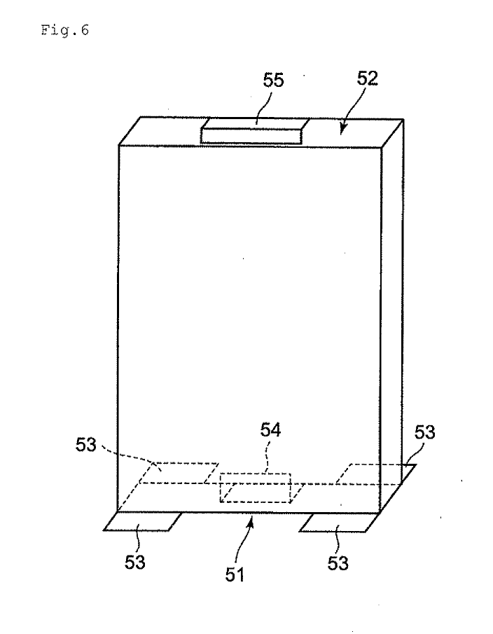

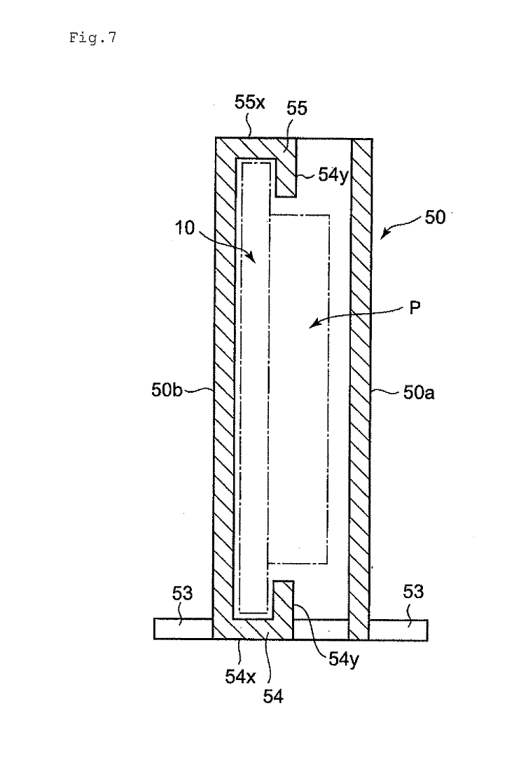

FIG. 4 is an explanatory front view schematically illustrating a protective case for a greeting card according to the present invention, and FIG. 5 is an explanatory rear view schematically illustrating the same. FIG. 6 is an explanatory perspective view schematically illustrating a state where the greeting card is housed to be stood in the protective case, and FIG. 7 is an explanatory cross-sectional view schematically illustrating the same.

In FIG. 4 to FIG. 7, 50 denotes a transparent plastic case body having a rectangular tube shape, and the case body 50 includes a lower opening 51 and an upper opening 52. A protruding piece 53a for forming a foot part is formed at the lower opening 51 of the case body 50 so as to be outwardly bendable. No particular limitation is imposed on the number of the protruding pieces 53a for forming the foot part. It is preferable to provide, for example, four protruding pieces 53a in total, that is, two on both sides of a front wall part 50a of the case body 50 and two on both sides of a rear wall part 50b thereof. This is because four foot parts 53 can be obtained by outwardly bending them as illustrated in FIG. 6, leading to a stable standing state.

In addition, a protruding piece 54a for forming a greeting card receiving part is formed on a rear wall part 50b at the lower opening 51 of the case body 50 so as to be inwardly bendable. As illustrated in FIG. 7, a lower end receiving part 54 for the card body 10 is formed by inwardly bending the protruding piece 54a, and when the greeting card is housed inside, the lower end receiving part 54 serves to prevent the greeting card from falling through the lower opening 51. The lower end receiving part 54 may be formed of only a horizontal receiving part by inwardly bending it once, and it is desirable that the lower end receiving part 54 is formed of a horizontal receiving part 54x and a vertical receiving part 54y by inwardly bending them twice. This is because the lower end of the card body 10 is inserted into a recess portion formed by the rear wall part 50b of the case body 50, the horizontal receiving part 54x, and the vertical receiving part 54y, thereby it can be held and fixed more stably.

Meanwhile, a protruding piece 55a for forming a greeting card engaging part is formed on the rear wall part 50b at the upper opening 52 of the case body 50 so as to be inwardly bendable. As illustrated in FIG. 7, an upper end engaging part 55 for the card body 10 is formed by inwardly bending the protruding piece 55a, and when the greeting card is housed inside, the upper end engaging part 55 serves to prevent the greeting card from falling through the upper opening 52. Similarly to the lower end receiving part 54, it is desirable that the upper portion engaging part 55 be formed of a horizontal engaging part 55x and a vertical engaging part 55y by bending them twice, in order to hold and fix the upper end of the card body 10 more stably.

Note that, a specific method of forming the case body 50 itself is not limited, and it is desirable that each bent part of the case body 50 is subjected as appropriate to an embossing, a half-cutting and other processes, because a bending process is facilitated.

In the case where the three-dimensional greeting card according to the present invention is housed in such a protective case as described above to be transported or stored, first, the card body 10 including the picture part P is inserted from the upper opening 52 or the lower opening 51 of the case body 50. Next, the protruding piece 54a for forming the greeting card receiving part and the protruding piece 55a for forming the greeting card engaging part are inwardly bent in the appropriate order, to form the receiving part 54 and the engaging part 55, so that the lower end and the upper end of the card body 10 are held and fixed. In this case, if the protruding piece 53a for forming the foot part is outwardly bent to form the foot part 53, the foot part 53 protrudes from the case body 50, and such a protruding state is not suitable for packing. Accordingly, it is preferable to transport the three-dimensional greeting card housed in the protective case without outwardly bending the protruding piece 53a.

In this way, the use of the protective case according to the present invention enables safe transportation and storage of the three-dimensional greeting card having a thick body without impairing it.

In the meantime, a person who receives the greeting card outwardly bends the protruding piece 53a for forming the foot part to form the foot part 53, whereby it can be viewed in a standing state.

Moreover, in the case where the constituent picture piece 31 is detachably attached by the sheet fastener, the layout of the picture part P can be changed depending on his/her taste.

### REFERENCE SIGNS LIST

P: picture part
10: card body
20: two-dimensional picture part
30: three-dimensional picture part
31: constituent picture piece
31A, 31B: sheet fastener part
32: spacer
32A, 32B: sheet fastener part
50: case body
50a: front wall part
50b: rear wall part
51: lower opening
52: upper opening
53: foot part
53a: protruding piece for forming foot part
54: receiving part
54a: protruding piece for forming receiving part
54x: horizontal receiving part
54y: horizontal receiving part
55: engaging part
55a: protruding piece for forming engaging part
55x: horizontal engaging part
55y: vertical engaging part

1-5. (canceled)

6. A three-dimensional greeting card comprising a picture part formed in at least part of a greeting card body, the picture part being defined by a selected number of constituent picture pieces connected together on top of one another.

7. The three-dimensional greeting card according to claim 6, wherein the constituent picture pieces are detachably connected together on top of one another by a sheet fastener.

8. A protective case for a greeting card, comprising a transparent plastic case body including upper and lower openings, the protective case further comprising:
a protruding piece forming a foot part, the protruding piece being formed at the lower opening so as to be outwardly bendable; and
a protruding piece forming a greeting card receiving part, the protruding piece being formed at the lower opening so as to be inwardly bendable.

9. The protective case for a greeting card according to claim 8, further comprising a protruding piece forming a greeting card engaging part, the protruding piece being formed at the upper opening of the transparent plastic case body so as to be inwardly bendable.

10. A three-dimensional greeting card comprising the greeting card recited in claim 6 housed in the protective case as recited in claim 8.

11. A three-dimensional greeting card comprising the greeting card recited in claim 6 housed in the protective case as recited in claim 9.
